(19) United States
(12) Patent Application Publication
(10) Pub. No.: US 2007/0175980 A1
(43) Pub. Date: Aug. 2, 2007

(54) Clinical decision support system for guideline selection and knowledge/location indication with the guideline

(75) Inventor: Yasser H. Alsafadi, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninkiljke Philips Electronics, N.V., Eindhoven (NL)

(21) Appl. No.: 10/596,423

(22) PCT Filed: Dec. 13, 2004
(86) PCT No.: PCT/IB04/52791

§ 371 Date: Jun. 13, 2006

Related U.S. Application Data
(60) Provisional application No. 60/529,786, filed on Dec. 16, 2003.

(51) Int. Cl. G06K 5/00; G06F 17/00

(52) U.S. Cl. 235/380; 235/375

(57) ABSTRACT

A clinical decision support system (30) displays a patient treatment guideline (20) for a given patient in response to a query from a medical practitioner along with an indicator (21) as to what state in the patient treatment guideline (20) the current patient is. According to one aspect of the present invention, an exemplary embodiment of a method (40) for interacting with a medical record of a patient includes: entering a patient identification (43) into a user interface (33) along with a care provider identification; selecting a patient treatment guideline (45) based on the entered information; and displaying the patient treatment guideline (46) on the user interface (33) along with an indicator (21) identifying a current point in the patient treatment guideline (20). An exemplary embodiment of an apparatus (30) for interacting with a medical record of a patient includes storage (32), a user interface (33) and a processor (31). The storage (32) stores one or more patient treatment guidelines (20). The user interface (33) accepts a command from a user identifying a patient and context information and displays a selected patient treatment guideline (20) from among the one or more patient treatment guidelines (20). The processor (31) searches the storage (32) for the selected patient guideline (20) that matches the identified patient and the context information.

The present invention relates generally to expert systems, and more particularly to an expert system for use in assisting a providing healthcare to a patient.

Many professional societies (e.g., ACP-ASIM, ACR, ACC, etc.) prepare guidelines for the care of patients. Nevertheless, the guidelines are usually in paper or html form. The clinician has to select which guideline is suitable for the current setting and navigate many pages to find out where in the guideline the current patient state applies, or which knowledge is relevant in the current episode of care.

The present invention is therefore directed to the problem of developing a method and apparatus for providing simplifying the paperwork for a medical practitioner when caring for a patient.

The present invention solves these and other problems by providing a clinical decision support system that displays a patient treatment guideline for a given patient in response to a query from a medical practitioner along with an indicator as to what state in the patient treatment guideline the current patient is.

According to one aspect of the present invention, an exemplary embodiment of a method for interacting with a medical record of a patient includes: entering a patient identification into a user interface along with a care provider identification; selecting a patient treatment guideline based on the entered information; and displaying the patient treatment guideline on the user interface along with an indicator identifying a current point in the patient treatment guideline.

According to another aspect of the present invention, an exemplary embodiment of an apparatus for interacting with a medical record of a patient includes storage, a user interface and a processor. The storage stores one or more patient treatment guidelines. The user interface accepts a command from a user identifying a patient and context information and displays a selected patient treatment guideline from among the one or more patient treatment guidelines. The processor searches the storage for the selected patient guideline that matches the identified patient and the context information.

According to yet another aspect of the present invention, an exemplary embodiment of a computer readable media has encoded thereon instructions that cause one or more processors to perform the following: receive a patient identification from a user along with a care provider identification; select a patient treatment guideline based on the received user information; and display the patient treatment guideline on a user interface along with an indicator identifying a current point in the patient treatment guideline.

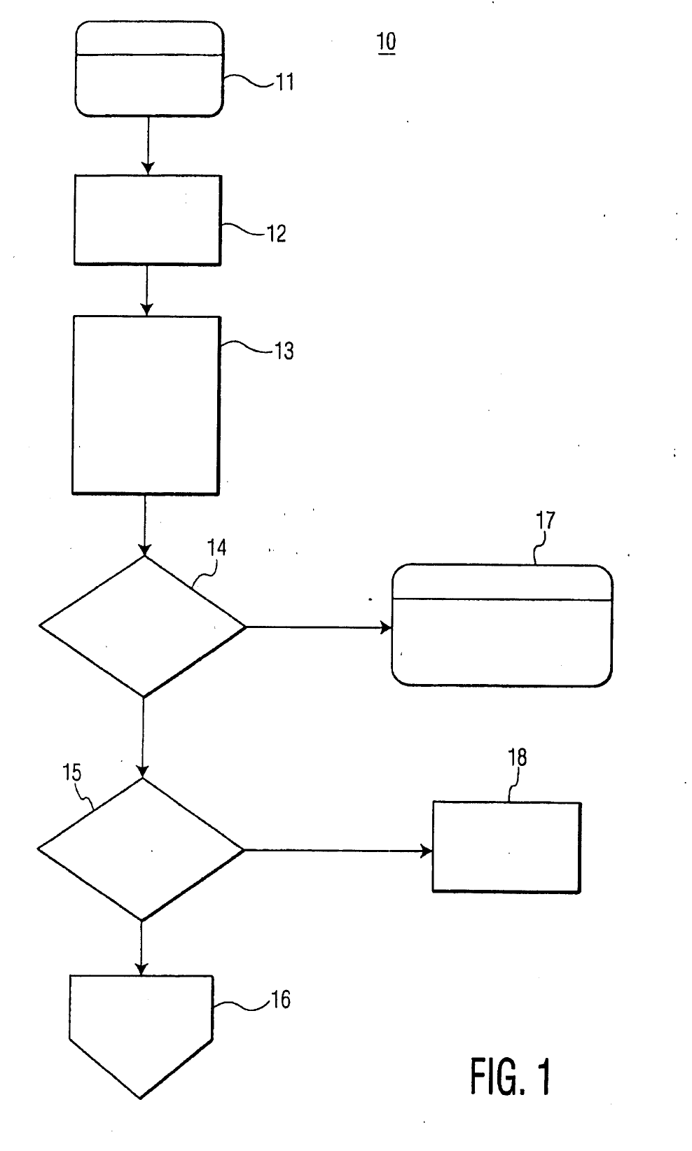

FIG. 1 shows an exemplary embodiment of a treatment guideline.

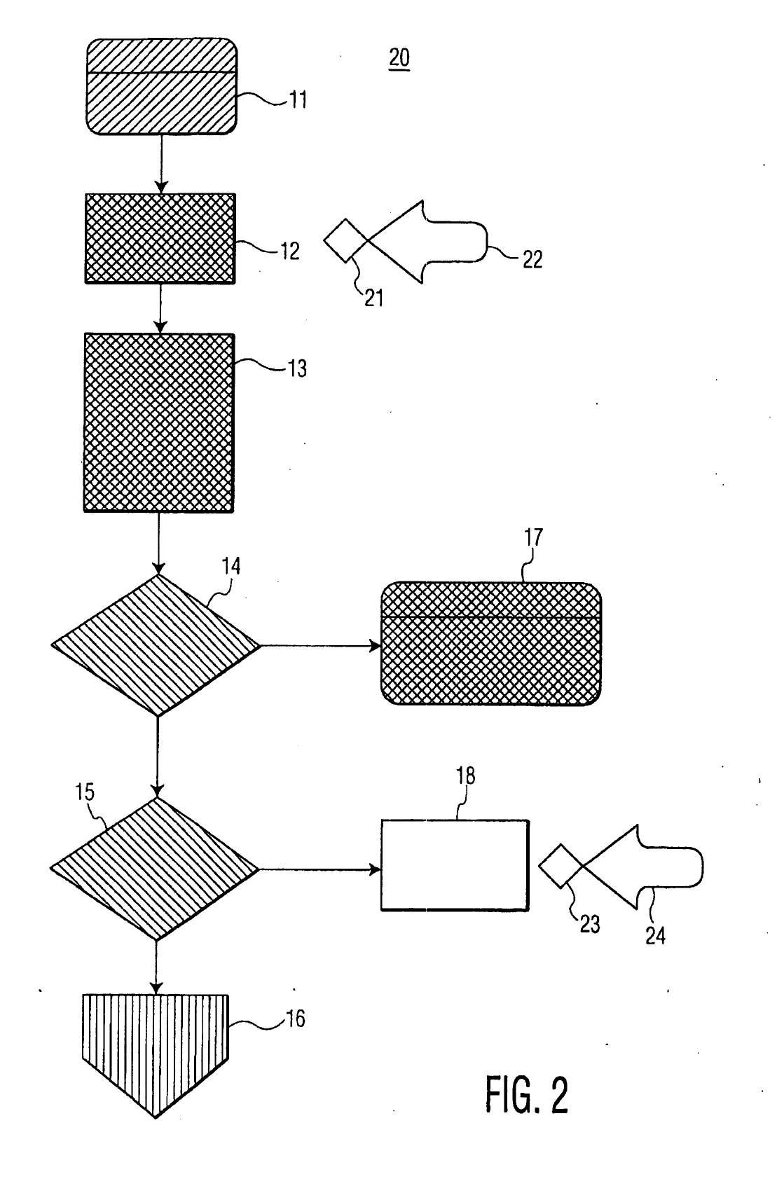

FIG. 2 shows an exemplary embodiment of a patient treatment guideline that is displayed to a medical practitioner or user along with a current treatment point according to one aspect of the present invention.

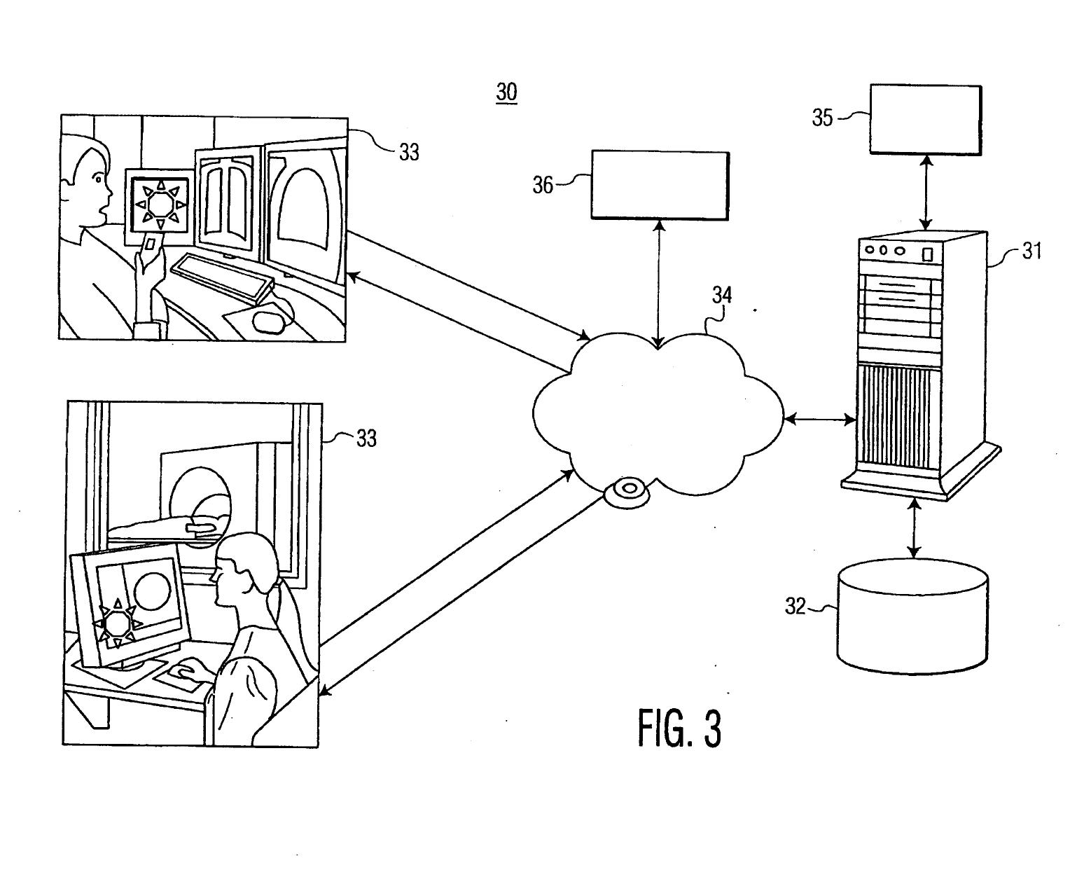

FIG. 3 shows an exemplary embodiment of an apparatus for interacting with a patient's medical records according to another aspect of the present invention.

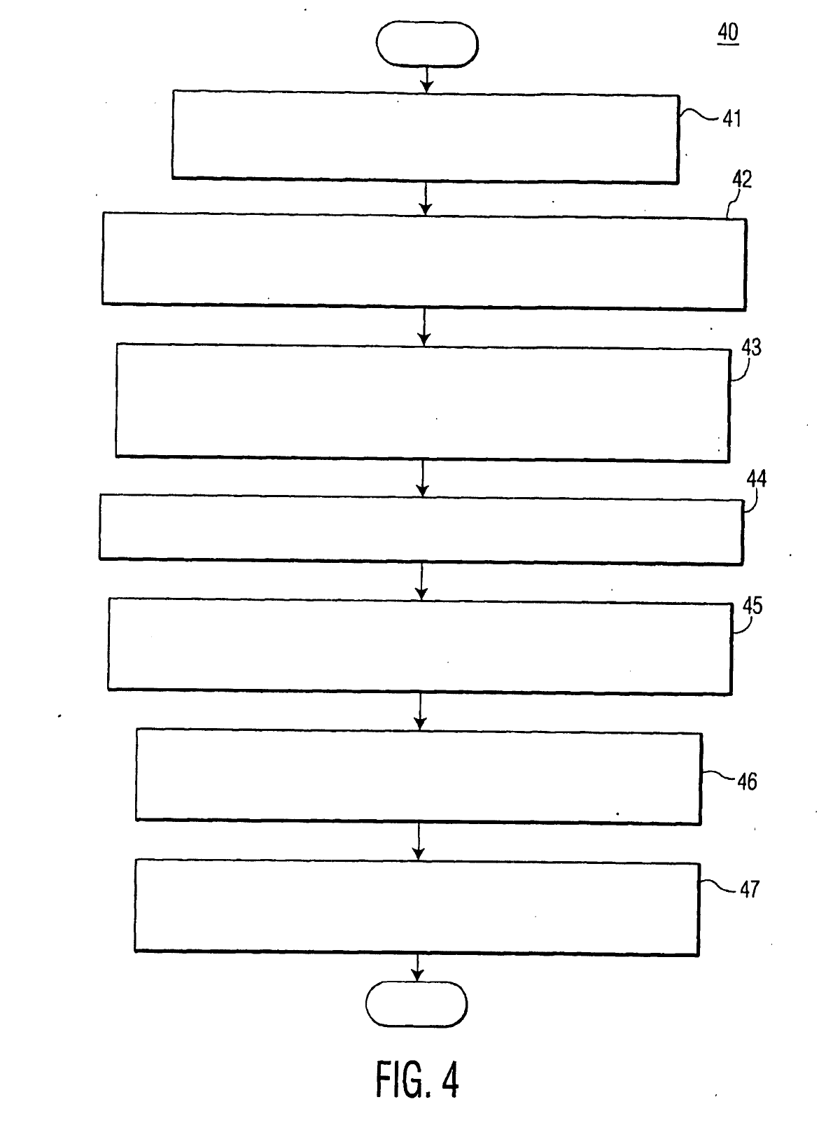

FIG. 4 shows a flow chart of an exemplary embodiment of a method for interacting with a patient's medical records according to yet another aspect of the present invention.

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

FIG. 1 shows an exemplary embodiment 10 of a standard treatment guideline when patient presents with certain symptoms, e.g., chest pains, under certain conditions. Each standard treatment guideline has a series of steps in a flow chart that should be performed when treating a patient that presents with the symptoms to which the guideline relates. According to one aspect of the present invention, each step in the process (e.g., steps 11-18) is coded with a subcode (e.g., 1201-1208) that is unique for the treatment guideline so that a computer and a database can associate other information relating to that step in a memory. For example, a treatment guideline for chest pains could be coded 1200 and the steps in the guideline 1200 could be 1201-12XX.

Existing evidence demonstrates that the use of clinical practice guidelines with other supportive tools, such as reminder systems, can improve the effectiveness of patient care. The key to success of computerized guidelines is to make the knowledge so readily available that the knowledge cannot be avoided. The most promising approach is to embed the knowledge into the technology that clinicians use to perform their jobs. This knowledge can then be brought to bear immediately without the physician having to seek out this knowledge.

The present invention comprises a clinical decision support system that selects the proper guideline for a patient given the context of the care for that patient from a guideline library. The clinical decision support system of the present invention provides a visual or audio indicator to the user on the current step in the guideline according to the context of care. An example of this is shown in FIG. 2, in which a patient treatment guideline is displayed along with a first indicator 21 for a certain context (context A) with a first arrow pointing 22 to the first indicator 21 and a second indicator 23 with a second arrow 24 pointing to the second indicator for a different context (context B). Only one of these context indicators would be shown at a time. These indicators are based on the context of the user and conditions existing when requesting the patient treatment guideline. According to the present invention, a clinical application submits a description of the clinical context and a clinical decision support server selects the proper guideline and provides a pointer to indicate the current position in the guideline (or relevant knowledge in the guideline). The steps in the process are shown in different shades to indicate different colors for different types of steps in the process, e.g., actions, patient states choice or decision steps, case step,

According to one exemplary embodiment of the present invention, a clinical decision support system 30 (shown in FIG. 3) includes a clinical decision support server 31, a guidelines repository 32, a user interface 33 and a patient record repository 35. A network 34, such as the Internet or some other private or public network couples these elements together.

The user interface 33, e.g., a desktop display with a pointing device and keyboard, enables a user to enter a query into the clinical decision support system 30. The user interface can be a graphical user interface, but need not be graphical. For example, a telephone voice activated system that uses voice recognition technology could be used to obtain the desired guidelines. A simple keyboard could be used to enter the contextual information to select the appropriate guidelines. Simply, all that required on the input side is that the user interface be able to obtain from the user a series of contextual tags or identification information, such as patient identification, user role and the care setting. Other information could be used as well to further refine the selection process in certain care settings and certain treatments.

As another example, input may be via an Radio Frequency (RF) identification reader that scans a patient's or clinician's identification to determine the patient or clinician. The patient and/or clinician may each have an RF identification tag that can be scanned by the RF ID reader. Such an RF tag may, for example, comprise a transponder that stores ID data in a non-volatile memory and transmits the ID data by modulating an RF resonant frequency generated by the RF identification reader. Such an RF ID reader and RF ID tag could be part of the user interface.

The clinical decision support server 31 receives the query and processes the query to select specific words, which are then used to identify the desired patient treatment guideline. For example, the context command received by the clinical decision support server 31 from the user interface 33 will include patient identification information. This is used to access the patient records to determine which treatment guidelines have been assigned previously to this patient. The remaining information in the context command will then be used to select among the assigned treatment guidelines. The clinical decision support server can be a standard network server.

Once identified, the identified guideline is then obtained from the guideline repository 32 and sent to the user interface 33 via the server 31 and a communication link 34, such as a network. The guideline can be sent to the display as an Adobe Acrobat® document (*.pdf) or some other well-defined format. The patient guideline can also be created from the standard treatment guide, which is then modified based on information contained in the identified patient medical records. The codes associated with the selected treatment guideline can be used to alter the standard treatment guideline to indicate those portions of the standard treatment guideline that have been completed or remain to be completed. For example, when the physician assigns a treatment guideline to a given patient, the physician could assign portions of the standard guideline that are appropriate for the given patient. In this case, the codes for these steps are then placed in the patient medical records in, for example, a table associated with the assigned treatment guideline. As these steps are completed, the codes can be appended with a date, for example, indicating the date of the completion. Alternatively, only the codes associated with completed steps could be included in the table associated with the assigned treatment guideline.

The guideline repository may keep guidelines in different encodings such as ASBRU, GLIF, EON, GUIDE, PRODIGY, or PROforma to name a few. See for example, Peleg, M., et. al., “Comparing computer-interpretable guideline models: a case study approach,” Journal of the American Medical Informatics Association, Vol. 10, Number 1, pp. 52-68, January/February 2003, which is hereby incorporated by reference.

The user interface 33 will display the patient treatment guideline that matches the query. An indicator 21-24 is overlaid on the patient treatment guideline to indicate the next step to be performed in the guideline or the last step in the guideline that was performed. An example of these indicators (21-24) can be seen in FIG. 2, which shows a star 21, 23 with an arrow 22, 24 pointing to a certain place in the patient treatment guideline. Two arrows 22, 24 and two stars 21, 23 are shown, one for each of two different contexts.

The user query includes patient context information, user context information, care context information and other context information. Information from the patient records can be used to determine where in the guideline the patient's current treatment is. Alternatively, each patient's treatment can be stored in the form of the guideline and updated by the physician or some other medical practitioner based on the patient's chart.

The CDSS Server makes selections and determines pointers by establishing context. For example the context could be described as:

Context {

Patient Context {

Patient Age;
Patient Gender;
Associated Condition: Coded concepts that indicate conditions;
}

User Context {

User Role: physician, nurse, medical student, ...;
}

Care Setting Context {

Setting: ICU, Ambulatory care, ...;
Modality: CT, XRAY, Clinical Information System, ...
}

Other Contexts {

Date, Time;
/*some guidelines use different sub-guidelines (weekdays/weekends,

day/night)*/

}

}

The pointer indicator could be visual/audio, or other means to point a location on the guideline.

The patient context information includes patient identification, patient age, patient gender, and/or associated condition. The associated condition can be encoded using standard healthcare codes (e.g. SNOMED-CT or CPT codes) or other codes.

The user context information includes the user role, such as nurse, physician, medical student, specialist, etc.

The care setting context includes the care location, such as hospital, clinic, home, etc.

The other context information includes date, time, and other specific information that could be used to select among patient treatment guidelines.

Upon receipt of the query, the clinical decision support server 31 identifies the patient from among the patient context information. The patient records are then accessed to identify any and all patient treatment guidelines for the identified patient. Clearly, if there is only one patient treatment guideline for the patient, then this is the matching patient treatment guideline. If there is more than one patient treatment guideline, then the appropriate guideline is selected from among the multiple patient treatment guidelines using the remaining context information available in the query. For example, a patient could have a treatment guideline for chest pain, in which case there might be one for the physician, one for the attending nurse and yet another for the cardiologist. In this case, the appropriate guideline could be selected using the user role context information. Moreover, there might be a patient guideline associated with an emergency situation, in which case the guideline might be selected based on time and date (e.g., after hours on weekend, etc.). Once the selected guideline is identified, the patient treatment guideline is displayed on the user interface along with an indicator as to the place in the guideline where the last treatment occurred. This could be in the form of an arrow on the display, selected colors highlighting completed steps as opposed to incomplete steps, or an audio signal telling the caregiver where the last treatment completed in the patient treatment guideline. This might be useful in an instance where the information is being communicated via telephone to a third party. The display is not intended to instruct the physician as to the next step, but rather to indicate the prior course of treatment along with the recommended treatment guidelines. In certain limited instances, however, this patient treatment guideline could be used to instruct a trained medical clerk or nurse as to the appropriate step to take next.

Turning to FIG. 4, shown therein is a flowchart of an exemplary embodiment of a method 40 for interacting with a patient's medical documentation. This method enables a medical practitioner or clinician to obtain the appropriate medical documentation for a given patient and view and/or edit this information.

Upon presenting to a medical practitioner for the first time or for the first treatment for a given condition, a patient is assigned one or more treatment guidelines (step 41). These treatment guidelines are assigned and selected based on many factors, such as condition, medical role, date/time, emergency, non-emergency or other suitable factors. Once assigned, the appropriate treatment guideline is associated with the patient's medical records using, for example, standard medical codes, such as SNOMED-CT or CPT codes. The patient's medical records then contain an association or identification of the assigned treatment guidelines for that patient. Some patients may have more than one guideline. As part of the assignment of a treatment guideline to a given patient, the physician may include only portions of the treatment guidelines that are appropriate for the given patient. In this instance, this information can be stored in the patient's medical records in the form of, for example, a table associated with the assigned treatment guideline that includes entries for each assigned step of the treatment guidelines along with an entry to be filled when the associated step of the treatment guideline is completed. The codes associated with each step can be used to identify the steps of the treatment guideline in this table. A date code can be used as the entry when the step is completed. An example of such a table is included below:

Treatment Guideline for Chest Pains Code XXXXXX-YY

| Assigned Step | Completion Date |
|---|---|
| ZZZ1 | ##/##/####-####.## |
| ZZZ2 | |

In this table above, each assigned step has a code associated with it and a completion date, if any. If there is no completion date, then this step has not been completed. Many more codes would normally be shown, but are not for brevity purposes. Chest Pains Code XXXXXXX-YY is an alphanumeric code that represents the chest pain guideline, which can be stored in a database and retrieved using this alphanumeric code. Alternatively, codes can be stored in the table only for those steps that are completed along with a date code when completed. An example of such a table is included below:

Treatment Guideline for Chest Pains Code XXXXXX-YY

| Completed Steps (code) | Completion Date |
|---|---|
| ZZZ1 | ##/##/####-####.## |

In this table, only those codes having been completed are stored, along with a completion date.

The patient treatment guidelines can be stored in a treatment guideline repository (step 42). The patient treatment guideline can be modified to indicate those steps that have been completed in the treatment and those that remain to be performed. This can be accomplished by many techniques, such as overlaying a graphic to indicate the current point in the treatment or by using colors to highlight the completed steps versus the non-completed steps.

Alternatively, an association between the patient and a standard guideline can be stored so that when requested, the appropriate standard guideline is obtained from a repository of standard guidelines based on the stored association. In this case, a table of completed steps can be stored in the patient medical records in association with the treatment guideline. In this case, the treatment guidelines would employ an identifier for each step in the process, and the patient medical records would include the same identifiers for each completed step in the treatment guidelines.

When a medical practitioner receives a patient, the practitioner can then enter the patient identification into a user interface along with other contextual information, such as the care provider, location, etc. (step 43). As part of this step, this information is transmitted to a central server or other processor.

The medical practitioner can also enter the medical treatment codes associated with the treatment being provided, which can be used to filter the correct patient treatment guideline (step 44). In this case, this information is also transmitted at the same time or separately as the information in step 43 to the processor or server.

This information is then received by the server that parses the information to identify the appropriate patient treatment guideline (step 45). The identified guideline is then retrieved from the guideline repository and sent to the requesting medical practitioner or user (step 45).

The patient treatment guideline is then displayed on the user's display along with an indicator identifying the current point in the patient treatment guideline (step 46). This step can include retrieving a standard treatment guideline and then modifying the standard treatment guideline based on codes in the patient's medical records that indicate those steps that have been performed in the standard treatment guideline, or based on codes that were previously entered indicating those steps that are to be completed and of those, which steps have been completed.

As the medical practitioner or clinician treats the patient, the medical practitioner can enter the codes associated with the steps in the patient treatment guideline, which are then used to update the medical records of the patient as well as to update the patient treatment guideline, the updated version of which can be stored in the guideline repository (step 47).

Alternatively, the appropriate codes can be sent to the patient medical records, which are then inserted in to the file associated with the displayed patient treatment guideline. When the guideline is next requested, the standard guideline is retrieved from the guideline repository and then modified based on the treatment codes associated with that guideline from the patient medical records to identify the completed steps of the patient treatment guideline. Thus, the server merges the information from the patient medical records along with the standard treatment guideline to create a patient-specific treatment guideline, which is then sent to the user and displayed. The user can also edit the guideline by pointing to a step and selecting the step and then clicking on an associated completed button, which would then transmit a code associated with the newly completed step to the patient's medical records. The transmitted code would then be stored in the data associated with the selected patient treatment guideline along with the codes for the other completed steps, if any.

The above methods can be stored in computer readable media to be used to instruct one or more processors to perform these methods of the present invention. The computer readable media includes magnetic memory, optical memory, CD-ROM, DVD, EVD, memory stick, RAM, ROM, or any other memory capable of storing information.

Although various embodiments are specifically illustrated and described herein, it will be appreciated that modifications and variations of the invention are covered by the above teachings and are within the purview of the appended claims without departing from the spirit and intended scope of the invention. For example, certain codes are referred to that identify patient treatments, however, any code would suffice under the present invention. Furthermore, these examples should not be interpreted to limit the modifications and variations of the invention covered by the claims but are merely illustrative of possible variations.

1. A method (40) for interacting with a medical record of a patient comprising:
receiving (43) a patient identification into a user interface along with a care provider identification;
selecting (45) a patient treatment guideline based on the entered information; and
displaying (46) the patient treatment guideline (20) on the user interface along with an indicator (21) identifying a current point in the patient treatment guideline (20).

2. The method according to claim 1, wherein the current point includes a last completed treatment in the patient treatment guideline (20).

3. The method according to claim 1, wherein the current point includes a next treatment to be performed in the patient treatment guideline (20).

4. The method according to claim 1, further comprising:
storing (42) one or more patient treatment guidelines (20) in a database.

5. The method according to claim 1, further comprising:
assigning (41) a treatment guideline (20) to a patient.

6. The method according to claim 1, further comprising:
entering (44) a code identifying a treatment into the user interface and selecting (45) the patient guideline (20) based at least in part on the code.

7. The method according to claim 1, wherein said indicator (21) includes an arrow. (22) pointing to the current point in the patient treatment guideline (20).

8. The method according to claim 1, wherein said indicator (21) includes a color highlighting a next step in the patient treatment guideline (20).

9. The method according to claim 1, wherein said indicator includes a first color associated with all steps in the patient treatment guideline that have been completed and a second color associated with all steps in the patient treatment guideline that have not been completed and said first and second colors are different.

10. The method according to claim 1, further comprising:
storing (41, 42) one or more codes that identify one or more steps in a particular patient treatment guideline (20) that are to be performed for the given patient in the patient's medical records; and
appending (47) an indicator to each of said one or more codes upon completion of a step in the particular patient treatment guideline associated with said each of said one or more codes.

11. The method according to claim 1, further comprising:
storing (42) a code that identifies one step in a particular patient treatment guideline upon completion of said one step in the patient's medical records; and
modifying (47) a standard treatment guideline based on the stored code in the patient's medical records before displaying the patient treatment guideline.

12. An apparatus (30) for displaying a medical record comprising:
a storage (32) to store one or more patient treatment guidelines;
a user interface (33) to accept a command from a user identifying a patient and context information and to display a selected patient treatment guideline from among the one or more patient treatment guidelines; and
a processor (31) to search said storage for the selected patient guideline that matches the identified patient and the context information.

13. The apparatus according to claim 12, further comprising a network (34) coupling the user interface (33) to the processor (31), wherein said processor (31) comprises a server.

14. The apparatus according to claim 10, wherein the user interface (33) includes a RF Id reader (36) that automatically reads a patient identification and/or a clinician's identification and transmits this information to the processor (31).

15. The apparatus according to claim 14, wherein the user interface (33) includes a pointing device and a display.

16. A computer readable media having encoded thereon instructions that cause one or more processors to perform the following:
receive (43, 45) a patient identification from a user or from an automated system or a ID scanner/reader along with a care provider identification;
select (45) a patient treatment guideline based on the received user information; and
display (46) the patient treatment guideline on a user interface along with an indicator identifying a current point in the patient treatment guideline.

17. The computer readable media according to claim 16, wherein said instructions further cause the one or more processors to perform the following:
receive (45) a code identifying a treatment from the user interface; and
transmit (44) received user information to a processor, which selects (45) the patient guideline based at least in part on the code and the user information.

18. The computer readable media according to claim 16, wherein said indicator includes an arrow pointing to the current point in the patient treatment guideline.

19. The computer readable media according to claim 16, wherein said indicator includes a color highlighting a next step in the patient treatment guideline.

20. The computer readable media according to claim 16, wherein said indicator includes a first color associated with all steps in the patient treatment guideline that have been completed and a second color associated with all steps in the patient treatment guideline that have not been completed and said first and second colors are different.
